(19) United States
(12) Patent Application Publication
(10) Pub. No.: US 2016/0202563 A1
(43) Pub. Date: Jul. 14, 2016

(54) Display Unit with Touch Function, Manufacturing Method Thereof and Display Device

(71) Applicant: BOE TECHNOLOGY GROUP CO., LTD., Beijing (CN)

(72) Inventors: Yongchun Lu, Beijing (CN); Yong Qiao, Beijing (CN); Hongfei Cheng, Beijing (CN); Jianbo Xian, Beijing (CN)

(21) Appl. No.: 14/774,902

(22) PCT Filed: Dec. 1, 2014
(86) PCT No.: PCT/CN2014/092696

§ 371 Date: Sep. 11, 2015

(30) Foreign Application Priority Data
Aug. 5, 2014 (CN) 201410381530.5

(51) Int. Cl. G02F 1/1343; G02F 1/1333; G02F 1/1341; G06F 3/041

(52) U.S. Cl. CPC G02F 1/134309; G06F 3/0412; G02F 1/13338; G02F 1/13439; G02F 1/1341; G06F 2203/04103

(57) ABSTRACT

A display unit with touch function, a manufacturing method thereof and a display device. The display unit includes an array substrate and an opposing substrate which are cell-assembled together, and a display function layer disposed between the array substrate and the opposing substrate. First electrodes and second electrodes which do not contact each other are formed on the array substrate and/or the opposing substrate and are respectively taken as driving electrodes and sensing electrodes; materials for forming the first electrode and/or the second electrodes include topological insulators; and the first electrode and/or the second electrodes are provided with two-dimensional (2D) nanostructures and adhered to the array substrate and/or the opposing substrate through an adhesion layer. The display unit solves the problems of slow touch response rate, easy heat generation and large power consumption due to high resistance of first electrodes and second electrodes on the conventional display unit.

### TECHNICAL FIELD

Embodiments of the present invention relate to a display unit with touch function, a manufacturing method thereof and a display device.

### BACKGROUND

Touch screen is currently the most simple, convenient and natural human-computer interaction means. A traditional liquid crystal display (LCD) touch screen comprises a touch panel and a display panel which are independent of each other. Currently, a typical LCD touch screen is usually obtained by interestedly forming a touch panel and an LCD panel, and includes an “in-cell” LCD touch screen and an “on-cell” LCD touch screen.

But no matter which kind of LCD touch screen is adopted, the touch sensing principle is the same. As illustrated in FIG. 1, the LCD touch screen comprises a plurality of first electrodes 11 distributed along a first direction 101 and a plurality of second electrodes 21 distributed along a second direction 102. As illustrated in FIG. 2, an insulating layer 12 is disposed between the first electrodes 11 and the second electrodes 21 and used for the insulation between the first electrodes 11 and the second electrodes 21. As illustrated in FIG. 3, taking a capacitive touch panel as an example, when a finger 30 touches the screen, the capacitance between the first electrodes 11 and the second electrodes 21 at a touch position will be changed, so that the touch position can be detected, and hence the touch function can be achieved.

Generally, the first electrodes and the second electrodes of the LCD touch screen are usually made from a transparent conductive oxide (TCO). For instance, indium tin oxide (ITO) is adopted to form the first electrodes and the second electrodes. But as the electric resistivity of an ITO film is relatively higher, the touch response rate is slow; heat generation tends to occur; and the power consumption is large.

### SUMMARY

Embodiments of the present invention provide a display unit with touch function, a manufacturing method thereof and a display device.

At least one embodiment of the present invention provides a display unit with touch function, which comprises an array substrate and an opposing substrate which are cell-assembled together, and a display function layer disposed between the array substrate and the opposing substrate. First electrodes and second electrodes which do not contact each other are formed on the array substrate and/or the opposing substrate and are respectively taken as driving electrodes and sensing electrodes; materials for forming the first electrodes and/or the second electrodes include topological insulators; the first electrodes and/or the second electrodes are provided with two-dimensional (2D) nanostructures; and the first electrodes and/or the second electrodes made from the topological insulators and provided with the 2D nanostructures are adhered to the array substrate and/or the opposing substrate through an adhesion layer.

The embodiment of the present invention further provides a method for manufacturing a display unit with touch function, which comprises: forming a first electrode pattern and/or a second electrode pattern provided with 2D nanostructures by utilization of topological insulators; forming an array substrate and an opposing substrate, including: allowing the first electrode pattern and/or the second electrode pattern to be adhered to a first base of the array substrate and/or a second base of the opposing substrate through an adhesion layer, so as to form first electrodes and second electrodes which do not contact each other on the array substrate and/or the opposing substrate, in which the first electrodes and the second electrodes are respectively taken as driving electrodes and sensing electrodes; filling a display function layer between the array substrate and the opposing substrate; and allowing the array substrate and the opposing substrate to be cell-assembled.

The embodiment of the present invention further provides a display device, which comprises any foregoing display unit with touch function provided by the embodiments of the present invention.

### BRIEF DESCRIPTION OF THE DRAWINGS

Simple description will be given below to the accompanying drawings required to be used the description of the embodiments or the prior art to provide a more clear understanding of the technical proposals in the embodiments of the present invention or the prior art. Obviously, the drawings described below only involve some embodiments of the present invention.

FIG. 1 is a schematic diagram of first electrodes and second electrodes of a touch panel;

FIG. 2 is a schematic sectional view of the touch panel as shown in FIG. 1;

FIG. 3 is a schematic diagram illustrating the touch sensing principle of the capacitive touch panel as shown in FIG. 1;

FIG. 4 is a schematic diagram of a display unit with touch function, provided by an embodiment of the present invention;

FIG. 5 is a schematic diagram of another display unit with touch function, provided by an embodiment of the present invention;

FIG. 6 is a schematic diagram of another display unit with touch function, provided by an embodiment of the present invention;

FIG. 7 is a schematic diagram of another display unit with touch function, provided by an embodiment of the present invention;

FIG. 8 is a schematic diagram of another display unit with touch function, provided by an embodiment of the present invention;

FIG. 9 is a schematic diagram of another display unit with touch function, provided by an embodiment of the present invention; and

FIG. 10 is a schematic diagram of a 2D diamond structure provided by the embodiment of the present invention.

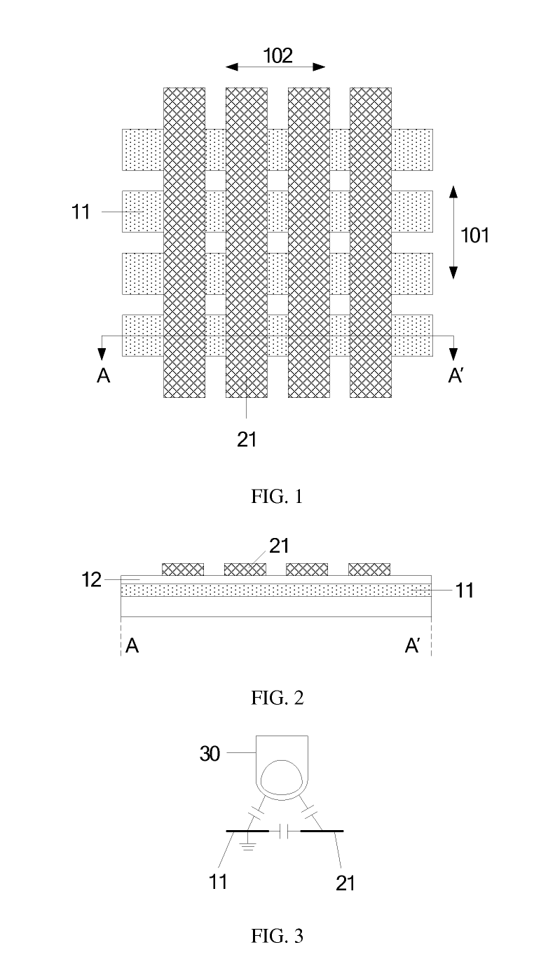

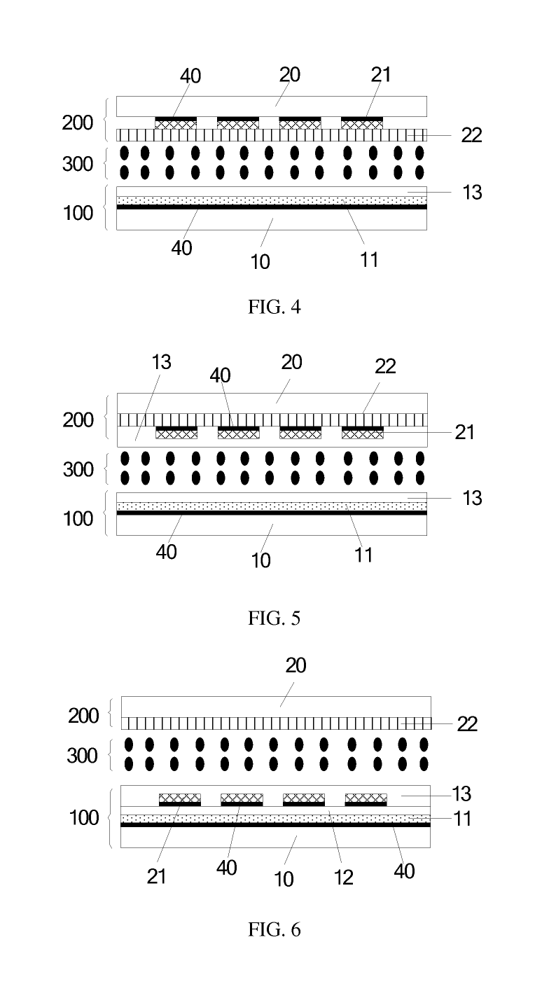

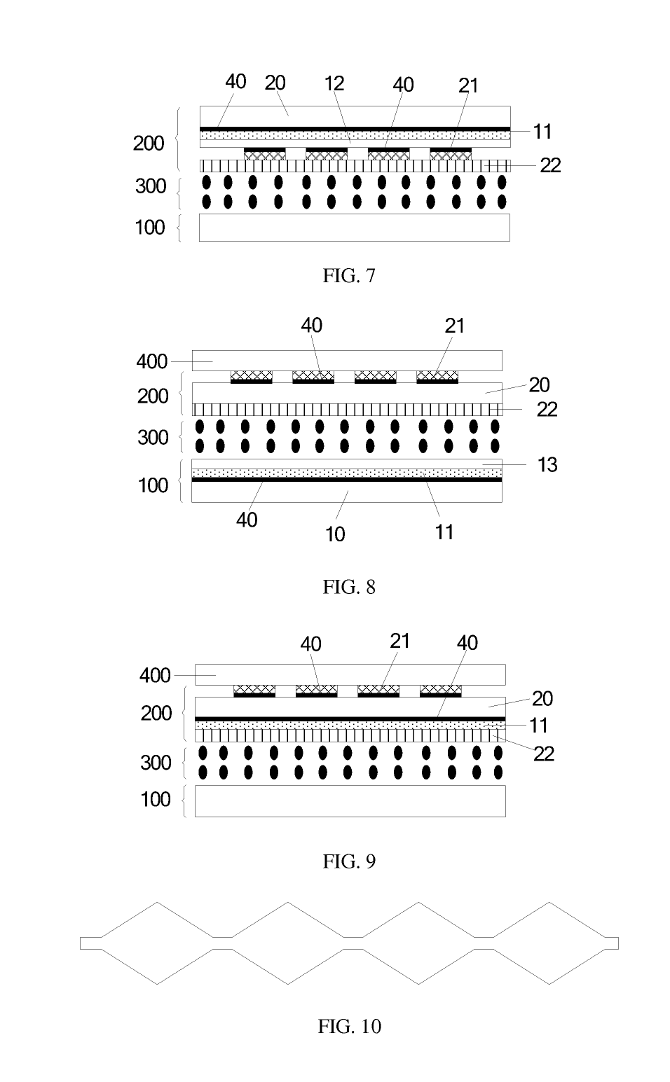

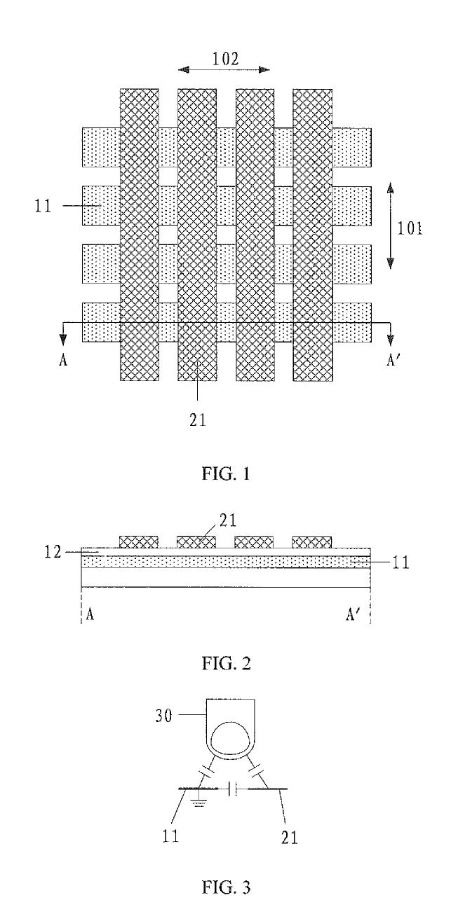

### REFERENCE NUMERALS

10—First Base; 11—First Electrode; 12—Insulating Layer; 13—Passivation Layer; 20—Second Base; 21—Second Electrode; 22—Color Filter (CF) Layer; 30—Finger; 40—Adhesion Layer; 100—Array Substrate; 200—CF Substrate; 300—Liquid Crystal Layer; 400—Package Substrate.

### DETAILED DESCRIPTION

Clear and complete description will be given below to the technical proposals of the embodiments of the present invention with reference to the accompanying drawings of the embodiments of the present invention. Obviously, the specific embodiments are only partial embodiments of the present invention but not all the embodiments. All the other embodiments obtained by those skilled in the art without creative efforts on the basis of the embodiments of the present invention shall fall within the scope of protection of the present invention.

Unless otherwise specified, the technical terms or scientific terms used in the disclosure have normal meanings understood by those skilled in the art. The words “first”, “second” and the like used in the disclosure do not indicate the sequence, the number or the importance but are only used for distinguishing different components.

The inventors in research have noted that: one of the research focuses in the field is to solve the problems of slow touch response rate, easy heat generation and large power consumption due to high resistance of first electrodes and second electrodes on a touch display.

In the following description of the disclosure, the case where first electrodes 11 are taken as driving electrodes and second electrodes 21 are taken as sensing electrodes is taken as an example. But in actual conditions, the first electrodes 11 may also be taken as the sensing electrodes and the corresponding second electrodes 21 are taken as the driving electrodes. That is to say, the first electrodes and the second electrodes may be interchanged as required.

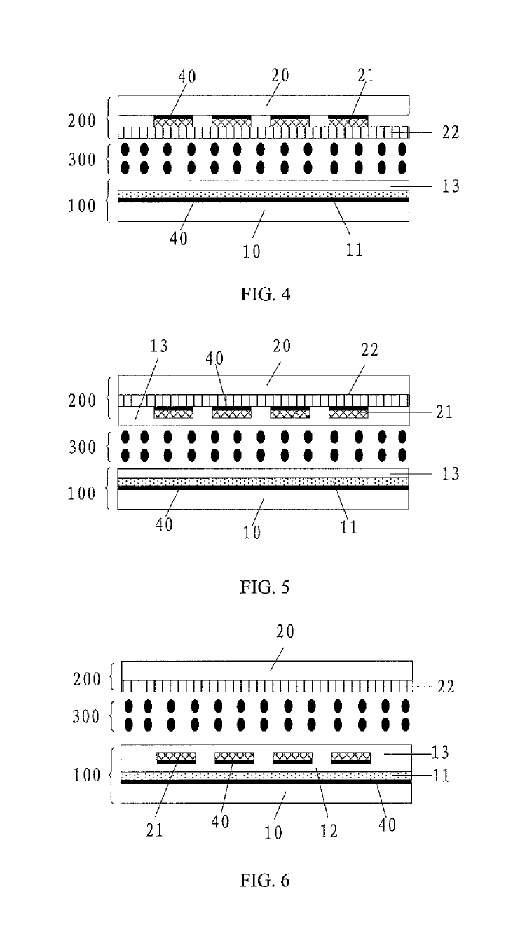

An embodiment of the present invention provides a display unit with touch function, which, as illustrated in FIGS. 4 to 9, comprises an array substrate 100 and a color filter (CF) substrate 200 which are cell-assembled together, and a display function layer disposed between the array substrate 100 and the CF substrate 200. In FIGS. 4 to 9, the case where the display function layer is a liquid crystal layer 300 is taken as an example. First electrodes 11 and second electrodes 21 which do not contact each other are formed on the array substrate 100 and/or the CF substrate 200. The first electrodes 11 and/or the second electrodes 21 include topological insulators having 2D nanostructures, which are adhered to the array substrate 11 and/or the CF substrate 21 through an adhesion layer 40. The first electrodes 11 and the second electrodes are respectively taken as driving electrodes and sensing electrodes.

In the disclosure, the CF substrate 200 is an example of an opposing substrate. When a CF layer is formed on the array substrate, namely when the array substrate is a color filter on array (COA) substrate, the opposing substrate may not be a CF substrate.

The material(s) for forming the first electrodes and/or the second electrodes include a topological insulator, namely the material for forming the first electrodes and/or the second electrodes may only include the topological insulator or may be a composite material formed with a topological insulator, polymer, etc. In the disclosure, detailed description is given in the embodiment of the present invention by taking the case where the material for forming the first electrodes and/or the second electrodes is a topological insulator as an example. But the description is not limited thereto.

It should be noted that the embodiment of the present invention takes the case where the display function layer is a liquid crystal layer as an example. The first electrodes and the second electrodes are formed on the array substrate and/or the CF substrate. That is to say, the first electrodes and the second electrodes may be formed on the array substrate and adhered to the array substrate through an adhesion layer; or the first electrodes and the second electrodes are formed on the CF substrate and adhered to the CF substrate through an adhesion layer; or the first electrodes and the second electrodes are respectively formed on the array substrate and the CF substrate. For instance, the first electrodes may be formed on the array substrate and the second electrodes are formed on the CF substrate. In this case, the first electrodes are adhered to the array substrate through an adhesion layer, and the second electrodes are adhered to the CF substrate through an adhesion layer. Or the second electrodes are formed on the array substrate and the first electrodes are formed on the CF substrate. In this case, the second electrodes are adhered to the array substrate through an adhesion layer, and the first electrodes ares adhered to the CF substrate through an adhesion layer. For instance, the first electrodes and the second electrodes may be adhered to the array substrate and/or the CF substrate through an adhesion layer formed by glue or the like substance with adhesive property.

The first electrodes and/or the second electrodes are of topological insulators having 2D nanostructures. For instance, only the first electrodes are of a topological insulator having 2D nanostructures, and the second electrodes may be conventional conductive material, for instance, may be made from ITO; or only the second electrodes are of a topological insulator having 2D nanostructures and the first electrodes may be made from a conventional conductive material; or both the first electrodes and the second electrodes are of topological insulators having 2D nanostructures. Moreover, detailed description is given in the embodiments and the accompanying drawings of the present invention by taking the case where both the first electrodes and the second electrodes are of topological insulators having 2D nanostructures as an example.

Topological insulator is a material form that is newly recognized in recent years. The energy band structure of the topological insulator is the same as that of an ordinary insulator, namely an energy gap of a limited size is formed in the Fermi level. But the boundary or surface of the topological insulator has a Dirac-type, spin-nondegenerate, conductive edge state without energy-gap, which is the most unique property of a topological insulator different from an ordinary insulator. The conductive edge state is stable, so that information can be transmitted by electronic spin and not by charges just like the traditional material. Therefore, the topological insulator has better electric conductivity and does not involve dissipation, namely does not generate heat.

The topological insulators having 2D nanostructures, namely films with a nano-size thickness formed by the topological insulators, may be 2D nano-films, 2D nano-sheets, 2D nano-belts and the like formed by the topological insulators. The topological insulators having 2D nanostructures have ultra-high specific surface area and controllability of energy band structures, can significantly reduce the proportion of body carriers and highlight the topological surface state, and hence have better conductivity.

It should be noted that the topological insulators having 2D nanostructures have high flexibility and high transmittance substantially invisible to human eyes as similar to graphene structure and hence are more applicable for display units.

It should be noted that the first electrodes and the second electrodes may be respectively taken as touch driving electrodes and touch sensing electrodes. Thus, when driving signals (Tx) are applied to the first electrodes, the second electrodes receive sensing signals (Rx). A capacitive touch screen determines whether there is a finger touch by calculating the variation of capacitance formed by the second electrodes and the first electrodes before and after finger touch, and hence achieves touch function.

In the display unit with touch function provided by an embodiment of the present invention, the first electrodes and/or the second electrodes are of topological insulators having 2D nanostructures. Compared with electrodes formed by ITO or metal, the resistance of the electrodes is greatly reduced, and hence the touch response rate can be improved. Moreover, the electrodes formed of the topological insulators having 2D nanostructures cannot generate heat after long-term use, and not only can reduce the power consumption but also can avoid the problem that high temperature disadvantageously affects the performances of other units.

It should be noted that other films, layer structures or the like are also formed on both the array substrate and the CF substrate. For instance, the array substrate is generally also provided with thin-film transistors (TFTs), pixel electrodes and so on, and the CF substrate is generally also provided with a CF layer, black matrix (BM), etc. In order to simplify the device, description is given in the disclosure by taking films or layer structures relevant to the present points of the present invention as an example.

For instance, the conductive film may have a 2D band nanostructure or a 2D diamond nanostructure. The 2D diamond nanostructure may be the structure as shown in FIG. 10. Of course, the conductive film may also be a 2D mesh nanostructure which is provided with a plurality of meshes distributed in arrays. For instance, the mesh may be in the shape of a diamond, a square, a regular hexagon, etc.

For instance, the topological insulator may include at least one selected from HgTe, BiₓSb₁₋ₓ, Sb₂Te₃, Bi₂Te₃, Bi₂Se₃, T₁BiTe₂, T₁BiSe₂, Ge₁Bi₄Te₇, Ge₂Bi₂Te₅, Ge₁Bi₂Te₄, AmN, PuTe, monolayer tin, and monolayer tin variant material.

Ge₁Bi₄Te₇, Ge₂Bi₂Te₅ and Ge₁Bi₂Te₄ belong to chalcogenide. AmN and PuTe belong to topological insulators with strong interaction. Of course, a topological insulator may also be a ternary Heusler compound or the like material.

For instance, the topological insulator may include at least one selected from HgTe, BiₓSb₁₋ₓ, Sb₂Te₃, Bi₂Te₃, Bi₂Se₃, T₁BiTe₂, T₁BiSe₂, Ge₁Bi₄Te₇, Ge₂Bi₂Te₅, Ge₁Bi₂Te₄, AmN, PuTe, monolayer tin and monolayer tin variant material, namely the topological insulator may be HgTe, BiₓSb₁₋ₓ, Sb₂Te₃, Bi₂Te₃, Bi₂Se₃, T₁BiTe₂, T₁BiSe₂, Ge₁Bi₄Te₇, Ge₂Bi₂Te₅, Ge₁Bi₂Te₄, AmN, PuTe, the monolayer tin or the monolayer tin variant material and may also be a composite material formed by a plurality of above materials, for instance, may be a composite material formed by two above materials. Of course, the topological insulator may also be a composite material formed by three above materials. Moreover, when the topological insulator is a composite material formed by at least two materials, materials with complementarities may also be selected and mixed to improve the properties of mixed materials.

For instance, the topological insulator is the monolayer tin or the monolayer tin variant material. Monolayer tin is a 2D material with the thickness of one tin atom and has good light transmittance due to the level of the atomic layer thickness. As similar to graphene, the monolayer tin has good flexibility and high light transmittance.

The electric conductivity of monolayer tin atom can reach 100% at room temperature. The monolayer tin may become a super-conductor material. For instance, the monolayer tin variant material is formed by the surface modification or magnetic doping of the monolayer tin. The surface modification of the monolayer tin may be the addition of —F, —Cl, —Br, —I, —OH and other functional groups into the monolayer tin to achieve the modification of the monolayer tin.

Moreover, for instance, the monolayer tin variant material is a tin fluorine compound formed by the surface modification of fluorine (F) atoms on the monolayer tin. When F atoms are added into a monolayer tin atom structure, the electric conductivity of the monolayer tin can also reach 100% at the high temperature of 100° C. and the properties are still stable.

Various aspects will be described below in detail: the first electrodes are disposed on the array substrate and the second electrodes are disposed on the CF substrate; or both the first electrodes and the second electrodes are disposed on the array substrate; or both the first electrodes and the second electrodes are disposed on the CF substrate. The first electrodes and the second electrodes are of topological insulators having 2D nanostructures.

For instance, as illustrated in FIGS. 4 and 5, the first electrodes 11 and the second electrodes 21 are of topological insulators having 2D nanostructures; the first electrodes 11 are disposed on the array substrate 100; and the second electrodes 21 are disposed on the CF substrate 200.

The array substrate 100 includes a first base 10; and the first electrodes 11 are formed on the side of the first base, which side is close to the CF substrate 200, are of a topological insulator having a 2D nano structure, and are adhered to the first base 10 through an adhesion layer 40. Moreover, as illustrated in FIGS. 4 and 5, a passivation layer 13 is also formed on the first electrodes 11 of the array substrate 100 and configured to prevent a liquid crystal layer 300 from contacting the first electrodes 11. Of course, the array substrate 100 may further include other films, layer structures, etc. The first electrodes 11 and the liquid crystal layer 300 may also do not contact each other due to provision of other films or layer structures. The embodiment of the present invention takes the structure as shown in FIGS. 4 and 5 as an example.

The CF substrate 200 includes a second base 20; and second electrodes 21 are formed on the side of the second base 20, which side is close to the array substrate 100, and are of a topological insulator having 2D nano structures.

It should be noted that the structure as shown in FIGS. 4 and 5 takes the case where the CF substrate 200 further includes a CF layer 22 as an example. When the second electrodes 21 are formed on the CF substrate 200, the structure may be as shown in FIG. 4; and the second electrodes 21 are disposed between the second base 20 and the CF layer 22 and adhered to the second base 20 through an adhesion layer 40. Or as shown in FIG. 5, the CF layer 22 is disposed between the second base 20 and the second electrodes 21; and the second electrodes 21 are adhered to the CF layer 21 through an adhesion layer 40. When the second electrodes 21 are disposed on the CF layer 22, as shown in FIG. 5, in order to prevent the contact between the second electrodes 21 and the liquid crystal layer 300, a passivation layer 13 is formed on the second electrodes 21. Of course, the CF substrate 200 may further include other films, layer structures, etc. The second electrodes 21 and the liquid crystal layer 300 may also do not contact each other due to provision of other films or layer structures. The embodiment of the present invention only takes the structure as shown in FIG. 5 as an example.

It should be noted that the terms such as “on” and “beneath” in the embodiment of the present invention is based on the sequence in the process of forming layers. For instance, an upper film or pattern is a film or pattern formed subsequently relatively, and a lower film or pattern is a film or pattern formed previously relatively. The CF layer generally includes layers of three different colors, namely red, green and blue and is provided with a black matrix (BM). The layers of different colors of the CF layer are divided into a plurality of pixels with different colors by the BM, so that color display can be achieved. Detailed description is given in the embodiments and the accompanying drawings of the present invention by taking the case where the CF substrate is also provided with the CF layer as an example. Of course, the array substrate and the CF substrate may further include other films or layer structures. The specific positions of the first electrodes and the second electrodes on the array substrate and the CF substrate may also be further adjusted. The embodiment of the present invention only takes the foregoing as an example and does not have specific limitations on other films or layer structures.

In the display unit with touch function provided by an embodiment of the present invention, as illustrated in FIG. 6, the first electrodes 11 and the second electrodes 21 are of topological insulators having 2D nano structures; both the first electrodes 11 and the second electrodes 21 are disposed on the array substrate 100; the first electrodes 11 and the second electrodes 21 do not contact each other through an insulating layer 12; the first electrodes 11 are adhered to the first base 10 through an adhesion layer 40; and the second electrodes 21 are adhered to the insulating layer 12 through an adhesion layer. As illustrated in FIG. 6, the array substrate 100 is also provided with a passivation layer 13 to prevent the contact between the second electrodes 21 and the liquid crystal layer 300. In FIG. 6, a CF layer 22 is also formed on the second base 20 of the CF substrate 200.

It should be noted that the first electrodes and the second electrodes are both disposed on the array substrate, do not contact each other, and may be arranged in the same layer. For instance, the first electrodes are disconnected at positions corresponding to the second electrodes, so that the first electrodes do not contact the second electrodes. Or the first electrodes and the second electrodes are arranged in different layers and do not contact each other by forming an insulating layer between the first electrodes and the second electrodes. As illustrated in FIG. 6, detailed description is given in the embodiment of the present invention by taking the case where the first electrodes 11 and the second electrodes 21 do not contact each other by forming the insulating layer 12 between the first electrodes 11 and the second electrodes 21 as an example.

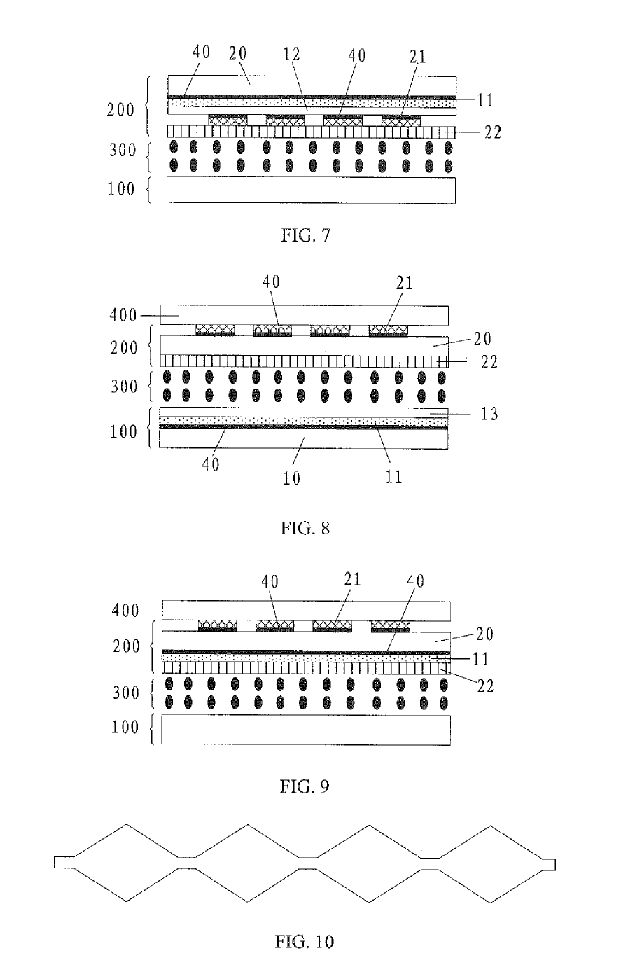

In the display unit with touch function provided by the embodiment of the present invention, as illustrated in FIG. 7, the first electrodes 11 and the second electrodes 21 are of topological insulators having 2D nanostructures; both the first electrodes 11 and the second electrodes 21 are disposed on the CF substrate 200. As illustrated in FIG. 7, the case where the first electrodes 11 and the second electrodes 21 are disposed between the second base 20 and the CF layer 22 and do not contact each other through the insulating layer 12 is taken as an example; the first electrodes 11 are adhered to the second base 20 through an adhesion layer 40; and the second electrodes 21 are adhered to the insulating layer 12 through an adhesion layer 40. Of course, the specific positions of the first electrodes 11 and the second electrodes 21 on the CF substrate 200 may also be correspondingly changed and adjusted. Detailed description is given in the embodiment of the present invention only by taking the structure as shown in FIG. 7 as an example.

It should be noted that the first electrodes and the second electrodes are both disposed on the CF substrate, do not contact each other, and may be arranged in the same layer. For instance, the first electrodes are disconnected at positions corresponding to the second electrodes, so that the first electrodes do not contact the second electrodes. Or the first electrodes and the second electrodes are arranged in different layers and do not contact each other by forming the insulating layer between the first electrodes and the second electrodes. As illustrated in FIG. 7, detailed description is given in the embodiment of the present invention by taking the case where the first electrodes 11 and the second electrodes 21 do not contact each other by forming the insulating layer 12 between the first electrodes 11 and the second electrodes 21 as an example.

Optionally, as illustrated in FIG. 8, the display unit with touch function further comprises a package substrate 400; the CF substrate 200 is disposed between the package substrate 400 and the array substrate 100; the first electrodes 11 and the second electrodes 21 are of topological insulators having 2D nanostructures; the first electrodes 11 are disposed on the array substrate 100; and the second electrodes 21 are disposed on the CF substrate 200.

Herein, the array substrate 100 includes first bases 10; and the first electrodes 11 are faulted on one side of the first base 10 close to the CF substrate 200, is a topological insulator having a 2D nanostructure, and is adhered to the first base 10 through an adhesion layer 40.

The CF substrate 200 includes a second base 20; and the second electrodes 21 are formed on one side of the second base 20 close to the package substrate 400, are of a topological insulator having 2D nanostructures, and are adhered to one side of the second base 20 close to the package substrate 400 through an adhesion layer 40. For instance, the second electrodes 21 are disposed between the CF substrate 200 and the package substrate 400. Of course, the second electrodes 21 may also be formed on the package substrate 400. Detailed description is given in the embodiment of the present invention by taking the case where the first electrodes and the second electrodes are respectively formed on the array substrate and the CF substrate as an example.

Optionally, as illustrated in FIG. 9, the display unit with touch function further comprises a package substrate 400; the CF substrate 200 is disposed between the package substrate 200 and the array substrate 100; and the first electrodes 11 and the second electrodes 21 are of topological insulators having 2D nanostructures and are both disposed on the CF substrate 200.

Herein, the CF substrate 200 includes a second base 20; the first electrodes 11 are formed on one side of the second base 20 close to the array substrate 100; the second electrodes 21 are formed on one side of the second base 20 close to the package substrate 400; the first electrodes 11 and the second electrodes 21 are of topological insulators having 2D nanostructures; the first electrodes 11 are adhered to one side of the second base close to the array substrate 100 through an adhesion layer 40; and the second electrodes 21 are adhered to one side of the second base 20 close to the package substrate 400 through an adhesion layer 40.

As illustrated in FIG. 9, the first electrodes 11 and the second electrodes 21 are respectively disposed on two opposite sides of the second base 20.

It should be noted that: as illustrated in FIGS. 4 to 9, the display unit with touch function comprises the array substrate 100, the CF substrate 200 and the liquid crystal layer 300 (namely the display function layer); both the array substrate 100 and the CF substrate 200 may further be provided with other films or layer structures; and the specific positions of the first electrodes 11 and the second electrodes 21 on the array substrate 100 and the CF substrate 200 may also be correspondingly changed. Description is given in the embodiment of the present invention by taking the structure as shown in FIGS. 4 to 9 as an example.

In addition, when the first electrodes and/or the second electrodes are disposed on the array substrate or the CF substrate, the first electrodes and/or the second electrodes may also be taken as common electrodes. In an LCD as shown in FIGS. 4 and 5, the second electrodes disposed on the CF substrate may also be taken as common electrodes, and the display time of the LCD is divided into touch periods and display periods. For instance, the display time of one frame is correspondingly divided into a touch period and a display period. When touch sensing signals are applied to the second electrodes in the touch period, namely the second electrodes receive sensing signals, and at this point, the first electrodes receive driving signals. Driving signals may also be applied to the second electrodes, at this point, the first electrodes receive sensing signals. In the display period, common electrode signals are applied to the second electrodes, at this point, the second electrodes are taken as common electrodes. Vertical electric fields are formed between the common electrodes and pixel electrodes on the array substrate.

An embodiment of the present invention provides a display device, which comprises any foregoing display unit with touch function provided by the embodiments of the present invention. The display device may be a display unit such as an LCD and any product or component with display function including the display unit such as a TV, a digital camera, a mobile phone, a watch, a tablet PC and a navigator.

An embodiment of the present invention provides a method for manufacturing the display unit with touch function provided by an embodiment of the present invention. The method comprises the following steps 101 to 104.

S101: forming a first electrode pattern and/or a second electrode pattern having 2D nanostructures by utilization of topological insulator.

When only first electrodes of the display unit are of a topological insulator having a 2D nanostructure, the first electrode pattern having 2D nanostructures is only required to be formed by utilization of the topological insulator; when only second electrodes of the display unit are of a topological insulator having 2D nanostructures, the second electrode pattern having 2D nanostructures is only required to be formed by utilization of the topological insulator; and when both the first electrodes and the second electrodes of the display unit are of topological insulators having 2D nanostructures, the first electrode pattern and the second electrode pattern having 2D nanostructures are formed by utilization of the topological insulators.

For instance, description is given to the manufacturing process of step 101 by taking the case where the first electrode pattern having the 2D nanostructures is formed by utilization of the topological insulator as an example. For instance, the manufacturing process of step 101 comprises steps 1011 to 1013.

S1011: forming a pattern corresponding to the first electrodes by etching with respect to a base.

For instance, the base may be mica, SrTiO3 (111) and other base capable of growing a topological insulator film on a surface thereof via molecular beam epitaxy (MBE). Detailed description is given in the embodiment of the present invention by taking the case where the base is mica as an example.

The process of forming the pattern corresponding to the first electrodes by etching on the base may be the case: a patterned mica base that is the same as the first electrode pattern may be obtained by the plasma etching on the mica base with the masking of a mask plate that is the same as the first electrode pattern.

S1012: forming a topological insulator film having 2D nanostructures on a surface of the patterned base.

For instance, a Bi₂Se₃ film is grown on the surface of the patterned mica base by MBE. Of course, another topological insulator film may also be grown. Detailed description will be given in the embodiment of the present invention by taking the case where the topological insulator is Bi₂Se₃ as an example.

S1013: removing the base and obtaining the first electrode pattern.

The topological insulator first electrode pattern having 2D nanostructures is obtained by the melting of the mica base.

The foregoing only takes the process of forming the pattern of the topological insulator first electrodes having 2D nanostructures as an example. The process of forming the pattern of the topological insulator second electrodes having 2D nanostructures may refer to the detailed description of the process of forming the pattern of the first electrode. No further description will be given in the embodiment of the present invention.

S102: forming an array substrate and a CF substrate.

For instance, the first electrode pattern and/or the second electrode pattern are adhered to the first base of the array substrate and/or the second base of the CF substrate through adhesion layers, so as to form the first electrodes and the second electrodes which do not contact each other on the array substrate and/or the CF substrate; and the first electrodes and the second electrodes are respectively taken as driving electrodes and sensing electrodes.

The first electrodes and the second electrodes are formed on the array substrate and/or the CF substrate, namely the first electrodes and the second electrodes may be formed on the array substrate; or the first electrodes and the second electrodes are formed on the CF substrate; or the first electrodes and the second electrodes are respectively formed on the array substrate and the CF substrate. That is to say, the first electrodes may be formed on the array substrate, and the second electrodes may be formed on the CF substrate; or the second electrodes are formed on the array substrate, and the first electrodes are formed on the CF substrate. In the embodiment of the present invention, the specific embodiments are used for describing the above several different conditions.

For instance, the process of allowing the first electrode pattern and/or the second electrode pattern to be adhered to the first base of the array substrate and/or the second base of the CF substrate through the adhesion layers may include: forming an adhesion layer on a surface of the first electrode pattern and/or the second electrode pattern, and allowing the first electrode pattern and/or the second electrode pattern to be correspondingly adhered to a first electrode region and/or a second electrode region of the first base of the array substrate and/or the second base of the CF substrate.

Taking the case where the first electrodes are formed on the array substrate as an example, for instance, the adhesion layer may be formed on the surface of the first electrode pattern, and one side of the first electrode pattern provided with the adhesion layer is adhered to the first electrode region of the first base of the array substrate to form the first electrode. It should be noted that the first base may be a glass substrate and may also be other film or layer structure formed on the glass substrate.

S103: filling a display function layer between the array substrate and the CF substrate.

For instance, the display function layer is filled between the array substrate and the CF substrate. A sealant may be formed on the array substrate and/or the CF substrate at first; subsequently, one drop filling is performed on a region defined by the sealant; and finally, an LCD function layer is formed.

S104: allowing the array substrate and the CF substrate to be cell-assembled.

For instance, as for the cell-assembly between the array substrate and the CF substrate, different cell-assembly means may be adopted according to the layer structures on the array substrate and the CF substrate. Description will be given below in the specific embodiments.

The manufacturing method provided by an embodiment of the present invention will be described below with reference to several embodiments.

### Embodiment 1

The embodiment of the present invention provides a method for manufacturing a display unit with touch function, which comprises steps 201 to 205.

S201: forming a first electrode pattern and a second electrode pattern having 2D nanostructures by utilization of topological insulators. For instance, the step 101 may be referred to.

S202: forming an adhesion layer on a surface of the first electrode pattern, and allowing the first electrode pattern to be adhered to a first electrode region on a first base.

Of course, a passivation layer or the like may also be formed on the first base, and the formed substrate may be the array substrate 100 as shown in FIG. 4 or 5. That is to say, first electrodes 11 are formed on the array substrate 100 and adhered to the first base 10 via an adhesion layer 40.

S203: forming an adhesion layer on a surface of the second electrode pattern, and allowing the second electrode pattern to be adhered to a second electrode region on a second base.

Of course, a CF layer, black matrix and so on may further be formed on the second base, and the formed substrate may be the CF substrate 200 as shown in FIGS. 4 and 5. That is to say, second electrodes 21 are formed on the CF substrate 200.

S204: filling a display function layer on the second base.

For instance, a sealant may be formed on the second base provided with the CF layer and the second electrodes, and hence one drop filling is performed on a sealant region to form an LCD function layer.

S205: allowing one side of the first base provided with the first electrodes and one side of the second base provided with the second electrodes to be opposite to each other and cell-assembled.

After cell-assembly, the display unit as shown in FIGS. 4 and 5 can be formed.

The first electrode pattern and/or the second electrode pattern having 2D nanostructures are formed by utilization of topological insulators, namely materials for forming the first electrode pattern and/or the second electrode pattern having 2D nanostructures may only include topological insulators and may also be composite materials formed by the topological insulator, polymer, etc. Detailed description is given in the embodiment of the present invention by taking the case where the materials for forming the first electrode pattern and/or the second electrode pattern are the topological insulators as an example.

It should be noted that the first electrode pattern corresponds to the first electrodes before adhered to the base; the second electrode pattern corresponds to the second electrodes before adhered to the base; the first electrode region corresponds to an adhesion position of the first electrodes; and the second electrode region corresponds to adhesion positions of the second electrodes.

### Embodiment 2

The embodiment of the present invention provides a method for manufacturing a display unit with touch function, which comprises steps 301 to 305.

S301: forming a first electrode pattern and a second electrode pattern having 2D nanostructures by utilization of topological insulators. For instance, the step 101 may be referred to.

S302: forming adhesion layers on surfaces of the first electrode pattern and the second electrode pattern, and allowing the first electrode pattern and the second electrode pattern to be respectively adhered to a first electrode region and a second electrode region of a first base.

Of course, a passivation layer and the like may further be formed on the first base, and the formed substrate may be the array substrate 100 as shown in FIG. 6. That is to say, first electrodes 11 and second electrodes 21 are formed on the array substrate 100; the first electrodes 11 are adhered to a first base 10 through an adhesion layer 40; and the second electrodes 21 are adhered to an insulating layer 12 through an adhesion layer 40.

S303: forming a CF substrate.

For instance, a CF layer and the like may be formed on a second base.

S304: filling a display function layer on the CF substrate.

For instance, a sealant may be formed on the second base provided with the CF layer, and hence one drop filling is performed on a sealant region to form an LCD function layer.

S305: allowing one side of the first base provided with the first electrodes and the second electrodes to be cell-assembled with the CF substrate.

After cell-assembly, the display unit as shown in FIG. 6 may be formed.

### Embodiment 3

The embodiment of the present invention provides a method for manufacturing a display unit with touch function, which comprises steps 401 to 405.

S401: forming a first electrode pattern and a second electrode pattern having 2D nanostructures by utilization of topological insulators. For instance, the step 101 may be referred to.

S402: forming adhesion layers on surfaces of the first electrode pattern and the second electrode pattern, and allowing the first electrode pattern and the second electrode pattern to be respectively adhered to a first electrode region and a second electrode region of a second base.

Of course, a CF layer and the like may further be formed on the second base, and the formed substrate may be the CF substrate 200 as shown in FIG. 7. That is to say, first electrodes 11 and second electrodes 21 are formed on the CF substrate 200; the first electrodes 11 are adhered to a second base 20 through an adhesion layer 40; and the second electrodes 21 are adhered to an insulating layer 12 through an adhesion layer 40.

S403: forming an array substrate.

For instance, TFTs, pixel electrodes and the like may be formed on a first base.

S404: filling a display function layer on the second base.

For instance, a sealant may be formed on the second base provided with the first electrodes, the second electrodes and the CF layer, and hence one drop filling is performed on a sealant region to form an LCD function layer.

S405: allowing one side of the second base provided with the first electrodes and the second electrodes to be cell-assembled with the array substrate.

After cell-assembly, the display unit as shown in FIG. 7 may be formed.

### Embodiment 4

The embodiment of the present invention provides a method for manufacturing a display unit with touch function, which comprises steps 501 to 505.

S501: forming a first electrode pattern and a second electrode pattern having 2D nanostructures by utilization of topological insulators. For instance, the step 101 may be referred to.

S502: forming an adhesion layer on a surface of the first electrode pattern, and allowing the first electrode pattern to be adhered to a first electrode region of a first base.

Of course, a passivation layer and the like may further be formed on the first base, and the formed substrate may be the array substrate 100 as shown in FIG. 8. That is to say, the first electrodes 11 are formed on the array substrate 100 and adhered to the first base 10 through an adhesion layer 40.

S503: forming an adhesion layer on a surface of the second electrode pattern, and allowing the second electrode pattern to be adhered to a second electrode region of the second base.

For instance, a CF layer and the like may be formed on one side of the second base not provided with second electrodes, and the formed substrate may be the CF substrate 200 as shown in FIG. 8. That is to say, second electrodes 21 and a CF layer 22 are formed on the CF substrate 200 and disposed on two opposite sides of a second base 20.

S504: filling a display function layer on the second base.

For instance, a sealant may be formed on the second base provided with the CF layer, and hence one drop filling is performed on a sealant region to form an LCD function layer.

S505: allowing one side of the first base provided with the first electrodes and one side of the second base not provided with the second electrodes to be opposite to each other and cell-assembled, and packaging one side of the CF substrate provided with the second electrodes via a package substrate.

After cell-assembly, the display unit as shown in FIG. 8 may be formed.

### Embodiment 5

The embodiment of the present invention provides a method for manufacturing a display unit with touch function, which comprises steps 601 to 605.

S601: forming a first electrode pattern and a second electrode pattern having 2D nanostructures by utilization of topological insulators. For instance, the step 101 may be referred to.

S602: forming adhesion layers on surfaces of the first electrode pattern and the second electrode pattern, and allowing the first electrode pattern and the second electrode pattern to be respectively adhered to a first electrode region and a second electrode region on two opposite sides of a second base.

Of course, a CF layer and the like may further be formed on the second base, and the formed substrate may be the CF substrate 200 as shown in FIG. 9. That is to say, first electrodes 11 and a CF layer 22 are formed on one side of a second base 20 of the CF substrate 200; second electrodes 21 are formed on the other side of the second base 20; and the first electrodes 11 and the second electrodes 21 are respectively adhered to the second base 20 through an adhesion layer 40.

S603: forming an array substrate.

For instance, TFTs, pixel electrodes and the like may be formed on a first base.

S604: filling a display function layer on the second base.

For instance, a sealant may be formed on the second base provided with the CF layer, and hence one drop filling is performed on a sealant region to form an LCD function layer.

S605: allowing one side of the second base provided with the first electrodes to be cell-assembled with the array substrate, and packaging the side of the CF substrate provided with the second electrodes via a package substrate.

After cell-assembly, the display unit as shown in FIG. 9 may be formed.

The embodiments of the present invention further provide a display unit with touch function, a manufacturing method thereof and a display device. The display unit with touch function comprises first electrodes and second electrodes which do not contact each other. The first electrodes and/or the second electrodes include topological insulators having 2D nanostructures. Compared with electrodes formed by ITO or metal, the resistance of the electrodes is greatly reduced, and hence the touch response rate can be improved. Moreover, as the electrodes formed by the topological insulators having 2D nanostructures will not generate heat after being used for a long time, not only the power consumption can be reduced but also the problem that high temperature affects the performances of other units can be avoided.

The foregoing is only the specific embodiments of the present invention and not intended to limit the scope of protection of the present invention. The scope of protection of the present invention should be defined by the appended claims.

The application claims priority to the Chinese patent application No. 201410381530.5, filed on Aug. 5, 2014, the disclosure of which is incorporated herein by reference as part of the application.

1. A display unit with touch function, comprising an array substrate and an opposing substrate which are cell-assembled together, and a display function layer disposed between the array substrate and the opposing substrate, wherein
first electrodes and second electrodes which do not contact each other are formed on the array substrate and/or the opposing substrate and are respectively taken as driving electrodes and sensing electrodes;
materials for forming the first electrodes and/or the second electrodes include topological insulators; and the first electrodes and/or the second electrodes are provided with two-dimensional (2D) nanostructures and adhered to the array substrate and/or the opposing substrate through an adhesion layer.

2. The display unit with touch function according to claim 1, wherein the materials for forming the first electrodes and the second electrodes include topological insulators; the first electrodes and the second electrodes are provided with 2D nanostructures;
the first electrodes are formed on the array substrates and the second electrodes are formed on the opposing substrate; or
both the first electrodes and the second electrodes are formed on the array substrate; or
both the first electrodes and the second electrodes are formed on the opposing substrate.

3. The display unit with touch function according to claim 1, wherein the first electrodes are formed on the array substrates and the second electrodes are formed on the opposing substrate;
the array substrate includes a first base; the first electrodes are formed on one side of the first base close to the opposing substrate;
the opposing substrate includes a second base; and the second electrodes are formed on one side of the second base close to the array substrate.

4. The display unit with touch function according to claim 1, further comprising a package substrate, wherein
the opposing substrate is disposed between the package substrate and the array substrate;
the first electrodes are formed on the array substrate; the second electrodes are formed on the opposing substrate;
the array substrate includes a first base; the first electrodes are formed on one side of the first base close to the opposing substrate;
the opposing substrate includes a second base; and the second electrodes are formed on one side of the second base close to the package substrate.

5. The display unit with touch function according to claim 1, further comprising a package substrate, wherein
the opposing substrate is disposed between the package substrate and the array substrate; both the first electrodes and the second electrodes are formed on the opposing substrate;
the opposing substrate includes a second base; the first electrodes are formed on one side of the second base close to the array substrate; and the second electrodes are formed on one side of the second base close to the package substrate.

6. The display unit with touch function according to claim 1, wherein the topological insulator includes at least one selected from HgTe, BiₓSb₁₋ₓ, Sb₂Te₃, Bi₂Te₃, Bi₂Se₃, T₁BiTe₂, T₁BiSe₂, Ge₁Bi₄Te₇, Ge₂Bi₂Te₅, Ge₁Bi₂Te₄, AmN, PuTe, monolayer tin and monolayer tin variant material.

7. The display unit with touch function according to claim 6, wherein the monolayer tin variant material is formed by the surface modification or magnetic doping of the monolayer tin.

8. The display unit with touch function according to claim 7, wherein the monolayer tin variant material is a tin fluorine compound formed by the surface modification of fluorine atoms on the monolayer tin.

9. The display unit with touch function according to claim 1, wherein the display function layer is a liquid crystal layer.

10. A method for manufacturing a touch unit with touch function, comprising:
forming a first electrode pattern and/or a second electrode pattern provided with 2D nanostructures by utilization of topological insulators;
forming an array substrate and an opposing substrate, including: allowing the first electrode pattern and/or the second electrode pattern to be adhered to a first base of the array substrate and/or a second base of the opposing substrate through an adhesion layer, so as to form first electrodes and second electrodes which do not contact each other on the array substrate and/or the opposing substrate, in which the first electrodes and the second electrodes are respectively taken as driving electrodes and sensing electrodes;
filling a display function layer between the array substrate and the opposing substrate; and
allowing the array substrate and the opposing substrate to be cell-assembled.

11. The manufacturing method according to claim 10, wherein materials for forming the first electrodes and the second electrodes include topological insulators; the first electrodes and the second electrodes are provided with 2D nanostructures; and the method further comprises:
packaging the opposing substrate via a package substrate, wherein
the first electrodes are formed on one side of the first base of the array substrate;
the second electrodes are formed on one side of the second base of the opposing substrate;
one side of the array substrate provided with the first electrodes and one side of the opposing substrate not provided with the second electrodes are opposite to each other and cell-assembled; and
one side of the opposing substrate provided with the second electrodes is packaged via the package substrate.

12. The manufacturing method according to claim 10, wherein materials for forming the first electrodes and the second electrodes include topological insulators; the first electrodes and the second electrodes are provided with 2D nanostructures; and the method further comprises:
packaging the opposing substrate via a package substrate, wherein
the first electrodes are formed on one side of the second base and the second electrodes are formed on other side of the second base;
the array substrate and one side of the opposing substrate provided with the first electrodes are opposite to each other and cell-assembled; and
one side of the opposing substrate provided with the second electrodes is packaged via the package substrate.

13. The manufacturing method according to claim 10, the step of forming the first electrode pattern and/or the second electrode pattern provided with the 2D nanostructures by utilization of the topological insulators comprises:
forming a pattern corresponding to the first electrodes and/or a pattern corresponding to the second electrode by etching with respect to a base;
forming a topological insulator film provided with 2D nanostructures on a surface of the patterned substrate; and
removing the base and obtaining the first electrode pattern and/or the second electrode pattern.

14. The manufacturing method according to claim 10, wherein the step of allowing the first electrode pattern and/or the second electrode pattern to be adhered to the first base of the array substrate and/or the second base of the opposing substrate through an adhesion layer comprises:
forming the adhesion layer on surfaces of the first electrode pattern and/or the second electrode pattern, and allowing the first electrode pattern and/or the second electrode pattern to be adhered to a first electrode region and/or a second electrode region corresponding to the first base of the array substrate and/or the second base of the opposing substrate.

15. A display device, comprising the display unit with touch function according to claim 1.

16. The display unit with touch function according to claim 2, wherein the first electrodes are formed on the array substrates and the second electrodes are formed on the opposing substrate;
the array substrate includes a first base; the first electrodes are formed on one side of the first base close to the opposing substrate;
the opposing substrate includes a second base; and the second electrodes are formed on one side of the second base close to the array substrate.

17. The display unit with touch function according to claim 2, further comprising a package substrate, wherein
the opposing substrate is disposed between the package substrate and the array substrate;
the first electrodes are formed on the array substrate; the second electrodes are formed on the opposing substrate;
the array substrate includes a first base; the first electrodes are formed on one side of the first base close to the opposing substrate;
the opposing substrate includes a second base; and the second electrodes are formed on one side of the second base close to the package substrate.

18. The display unit with touch function according to claim 2, further comprising a package substrate, wherein
the opposing substrate is disposed between the package substrate and the array substrate;
both the first electrodes and the second electrodes are formed on the opposing substrate;
the opposing substrate includes a second base; the first electrodes are formed on one side of the second base close to the array substrate; and the second electrodes are formed on one side of the second base close to the package substrate.

19. The display unit with touch function according to claim 2, wherein the topological insulator includes at least one selected from HgTe, BiₓSb₁₋ₓ, Sb₂Te₃, Bi₂Te₃, Bi₂Se₃, T₁BiTe₂, T₁BiSe₂, Ge₁Bi₄Te₇, Ge₂Bi₂Te₅, Ge₁Bi₂Te₄, AmN, PuTe, monolayer tin and monolayer tin variant material.

20. The display unit with touch function according to claim 19, wherein the monolayer tin variant material is formed by the surface modification or magnetic doping of the monolayer tin.
